(19) United States
(12) Patent Application Publication
(10) Pub. No.: US 2007/0044359 A1
(43) Pub. Date: Mar. 1, 2007

(54) Apparatus and methods for mounting a display sheet on a roll-up-type truck door

(75) Inventor: William A. Worley, Glendale, AZ (US)

Correspondence Address: LOUIS J. HOFFMAN, P.C., 14614 NORTH KIERLAND BOULEVARD, SUITE 300, SCOTTSDALE, AZ, 85254, US

(73) Assignee: Moving Images Media, LLC

(21) Appl. No.: 11/212,150

(22) Filed: Aug. 26, 2005

(51) Int. Cl. G09F 21/04

(52) U.S. Cl. 40/590

(57) ABSTRACT

An apparatus for displaying text on rear roll-up door of a truck comprises a flexible display sheet and a resilient lower anchoring assembly. The display sheet bears text or graphic indicia printed on it or otherwise applied to it and has extending across its bottom edge an elongated pocket with a plurality of transverse openings. The top edge of the sheet is secured to the outer surface of the roll-up-type truck door. The resilient lower anchoring assembly comprises an elongated substantially rigid member received within the elongated pocket and a plurality of spring members. Each spring member is secured at a first end to the elongated rigid member and at a second end to outer surface of the truck door, and passes through one of the transverse openings.

### BACKGROUND

The field of the present invention relates to truck-mounted visual displays. In particular, apparatus and methods are described herein for mounting a visual display sheet on a roll-up-type truck door.

A wide variety of visual displays are available for mounting on a truck. One common type of visual display for mounting on a truck comprises a flexible display sheet mounted on a surface of the truck, with various text or graphic indicia printed on or otherwise applied to the sheet. Such visual displays may commonly be mounted, for example, on one or more substantially flat, substantially vertical surfaces of the truck cargo compartment. Such mounting may be relatively straightforward on a wall of the truck. However, additional adaptations may be required for mounting such a visual display sheet onto a roll-up-type door of the truck.

A roll-up-type truck door typically comprises a plurality of hinged door panels arranged one above the next. Each panel is configured to travel upward along paired vertical tracks positioned on either side of the door, which are curved so that they extend horizontally just below the top of the truck cargo compartment. As the door is lifted, the hinged panels allow the door to follow the path of the curved tracks and to move into a horizontal position along the top of the truck cargo compartment. The roll-up-type truck door, allows access to a cargo container of a vehicle referenced herein as a “truck,” however powered or shaped or whatever its function or typical uses.

A display sheet mounted on the outer surface of the roll-up-type door must accommodate the change in length caused by the curved path followed by the door as it is opened. Typically, the display sheet would be stretched lengthwise as a result of the motion of the hinged door panels as the door is opened. On the other hand, a variety of problems arise from loose mounting of the display sheet on the truck door panel, including damage to the sheet or deformation of the indicia thereon, or simply unattractive presentation, especially given that the display sheet is susceptible to movement in air flows caused by the truck's ordinary motion. It is desirable, further, to have the display sheet capable of being mounted and removed easily, without opening the door or requiring complex securing structure inside the truck cargo compartment.

The apparatus and methods disclosed for mounting a display sheet on a roll-up-type truck door avoid problems of this nature.

### SUMMARY

In one embodiment, an apparatus comprises a flexible sheet (i.e. a display sheet) and a resilient lower anchoring assembly. The sheet bears visually perceptible text or graphic indicia printed on it or otherwise applied to it. The sheet has extending along its bottom edge an elongated pocket with a plurality of transverse openings arranged along its length. The resilient lower anchoring assembly comprises an elongated rod or other substantially rigid member received within the elongated pocket and a plurality of spring members. Each spring member is adapted for being secured at its first end to the elongated rigid member and at its second end to the truck door, passing through one of the transverse openings. The apparatus can further comprise an upper anchoring member adapted for being secured to an outer surface of a roll-up-type truck door so as to secure the top edge of the sheet to the truck door.

A method for installing the sheet onto the truck door comprises securing the top edge of the sheet to the truck door and securing the resilient lower anchoring assembly to the bottom edge of the sheet and to the outer surface of the truck door. The lower anchoring assembly is secured to the sheet by inserting the elongated substantially rigid member into the elongated pocket, passing each one of the plurality of spring members through a corresponding one of the transverse openings, and securing first end of each spring member to the elongated rigid member. The lower anchoring assembly is secured to the outer surface of the truck door by securing the second end of each of the plurality of spring members to the truck door. The method can further comprise securing an upper anchoring member to the upper portion of the outer surface of the truck door to secure the top edge of the sheet to the truck door. The sheet can be removed from the truck door by: detaching the second end of each of the plurality of spring members from the truck door, detaching the top edge of the sheet from the truck door, and removing the sheet from the truck door.

The above summary does not include an exhaustive list of all aspects of the present invention. Indeed, the inventor contemplates that the invention includes all systems and methods that can be practiced from all suitable combinations of the various aspects summarized above, as well as those disclosed in the detailed description below and particularly pointed out in the claims filed with the application. Such combinations have particular advantages not specifically recited in the above summary.

### BRIEF DESCRIPTION OF THE DRAWINGS

FIG. 1 is a schematic plan view of the back end of a truck with a roll-up-type door and a display sheet mounted thereon.

FIGS. 2 and 3 are schematic plan and cross-sectional views, respectively, of a lower edge of a display sheet and a portion of a lower anchoring member.

FIG. 4 is a schematic cross-sectional view of a top edge of a display sheet and an upper anchoring member.

FIGS. 5 and 6 are schematic cross-sectional views of two embodiments of a lower edge of a display sheet and a lower anchoring member.

The embodiments shown in the Figures are exemplary, and should not be construed as limiting the scope of the present disclosure and/or appended claims.

### DETAILED DESCRIPTION OF EMBODIMENTS

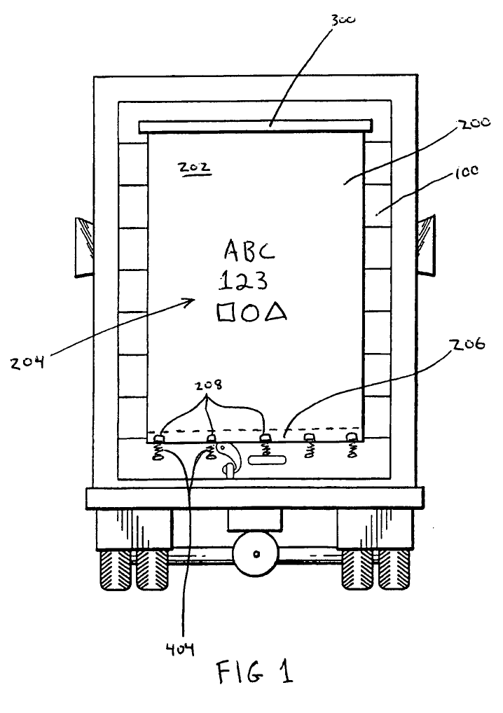

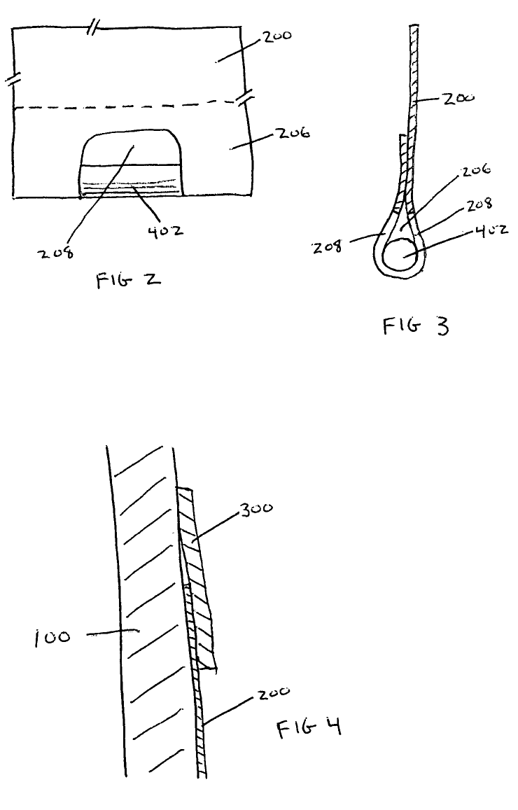

FIGS. 1-6 illustrate a flexible display sheet secured to a roll-up-type truck door. The flexible display sheet bears visually perceptible text or graphic indicia printed on it or otherwise applied to it. The indicia may comprise advertising, information, logos, or any other desired indicia.

As shown in FIG. 1, a flexible sheet 200 (i.e., the display sheet) is held in place on a roll-up-type truck door by an upper anchoring member 300 and a resilient lower anchoring assembly 400. The display sheet 200 has a top edge, a bottom edge, and a front surface 202 bearing text or graphic indicia 204 printed on it or otherwise applied to it. As shown in FIGS. 1, 2 and 3, the display sheet 200 is formed at its bottom edge into, or has affixed thereto, an elongated pocket 206 extending across the bottom edge of the display sheet 200, the pocket 206 having a plurality of transverse openings 208 arranged along its length. The upper anchoring member 300 is adapted for being secured to an outer surface of a roll-up-type truck door 100 to secure the top edge of the display sheet 200 to an upper portion of the truck door 100 with the front surface 202 of the display sheet 200 facing away from the truck door 100. The resilient lower anchoring assembly 400 comprises a rod or other elongated substantially rigid member 402 received within the elongated pocket 206 and a plurality of spring members 404. Each spring member 404 is adapted for being secured at a first end to the elongated rigid member 402 and at a second end to the outer surface of the truck door 100. When installed onto the truck door 100, the upper anchoring member 300 is secured to the truck door 100 to secure the top edge of the display sheet 200 to the upper portion of the truck door 100. When installed o the truck door 100, each spring member 404 is secured at its first end to the elongated rigid member 402, passes through one of the transverse openings 206, and is secured at its second end to the lower portion of the truck door 100, thereby securing the resilient lower anchoring assembly 400 to the truck door.

A method for installing the display sheet 200 onto the truck door 100 comprises securing the upper anchoring member 300 to the upper portion of the outer surface of the truck door 100, to secure the top edge of the display sheet 200 to the truck door, and securing the resilient lower anchoring assembly 400 to the bottom edge of the display sheet 200 and to the lower portion of the outer surface of the truck door 100. The lower anchoring assembly 400 is secured to the display sheet 200 by inserting the elongated substantially rigid member 402 into the elongated pocket 206, passing each one of the plurality of spring members 404 through a corresponding one of the transverse openings 208, and securing its first end to the elongated rigid member 402. The lower anchoring assembly 400 is secured to the truck door 100 by securing the second end of each of the plurality of spring members 404 to the truck door 100. The display sheet 200 can be removed from the truck door 100 by detaching the second end of each of the plurality of spring members 404 from the truck door 100, detaching the upper anchoring member 300 from the truck door 100, and removing the display sheet 200 from the truck door 100.

As the roll-up-type truck door 100 is opened and the hinged door panels move along the curved tracks, the resilient lower anchoring assembly 400 accommodates the resulting increase in length along the front of the door spanned by the display sheet 200. In particular, the spring members 404 expand with increased tension applied to the display sheet 200 by the opening of the door 100, thereby substantially preventing damage to or deformation of the display sheet 200. The resilient lower anchoring assembly 400 serves to maintain the display sheet 200 in a substantially non-wrinkled arrangement, by distributing the tension applied by spring members 404 over the length of the elongated member 402. The substantially non-wrinkled arrangement can be maintained even when the roll-up-type truck door 100 is opened, except where the sheet 200 spans the hinges of the door 100 and the sheet 200 folds along with the hinged door panels. Because the pocket 206 wherein the elongated member 402 is received is positioned along the lower edge of the sheet 200, there is no portion of the sheet 200 left flapping when it is secured to the truck door 100.

The transverse openings 208 can be arranged somewhat arbitrarily along the length of the elongated pocket 206 at the bottom edge of the sheet 200. The transverse openings 208 can be simply slits in the pockets or sections with some width cut out of the pocket material. The openings can be on only one side of the pocket or through both sides. There can be as few as two openings, or as many as dozens, but three, four, or five are preferred for standard seven- or eight-foot banner widths. The transverse openings 208 can be formed during manufacture of the sheet 200, or can be cut out during the installation of the sheet 200 onto the truck door 100. In this way, the transverse openings 208 can be arranged to correspond to mounting hardware (such as hooks, eyescrews, eyebolts, and the like) that may already be present on the lower portion of the outer surface of the truck door 100 or that can be affixed thereto during the mounting process. Display sheets of differing widths can be accommodated by suitable arrangement of the transverse openings 208 along the bottom edge of the sheet 200.

The top edge of the sheet 200 can be secured to the top portion of the outer surface of the truck door in a variety of ways, with or without an upper anchoring member 300. The following are exemplary only. In the embodiment of FIG. 4, the upper anchoring member 300 comprises an elongated member secured, in any suitable way, over the top edge of sheet 200 to the upper portion of the outer surface of the truck door 100, thereby securing the sheet to the truck door. In an alternative embodiment (not shown), the sheet 200 further comprises a bead member extending across the upper edge of the sheet 200, and the upper anchoring member 300 comprises a receiving member secured to the truck door 100 and adapted for engaging and retaining the bead member. In another alternative embodiment (not shown), the sheet 200 has an elongated top pocket extending across its top edge, with a plurality of transverse openings arranged along its length. The upper anchoring member comprises an elongated substantially rigid member received within the top pocket and a plurality of securing members passing through the openings and securing the rigid member to the truck door. Any other suitable upper anchoring member can be employed. In another alternative embodiment (not shown) tape or other adhesive is employed for securing the top edge of the display sheet 200 to the truck door 100. Tape can also be used to hold the top edge of the sheet in place while an upper anchoring member is installed. Any other suitable structures or methods may be employed for securing the top edge of the display sheet 200 to the truck door within the scope of the present disclosure or appended claims.

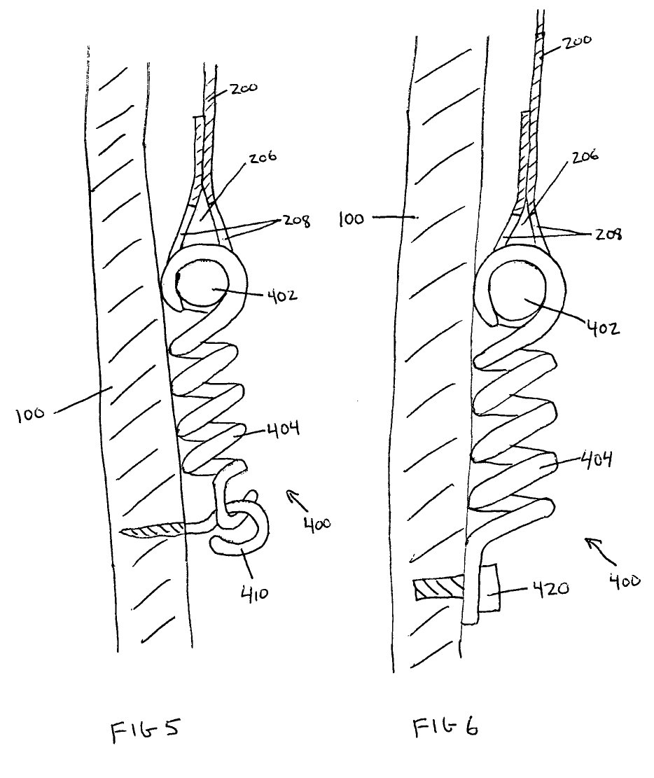

The spring members 404 may comprise coil springs with a hook at a first end and a hook (FIG. 5) or an eye (FIG. 6) at the second end. The hook at the first end receives therein the elongated member 402, thereby securing the spring member 404 to the elongated member 402. In a first embodiment (FIG. 4A), a plurality of eyescrews, eyebolts, or hooks 410 (eyescrews in FIG. 4A) are installed on the lower portion of the outer surface of the truck door 100. Each spring member 404 (secured by the hook at its first end to the elongated member 402) passes through a corresponding transverse opening 208, and is secured by a hook at its second end to a corresponding one of the plurality of eyescrews, eyebolts, or hooks 410. In another embodiment (FIG. 4B), each spring member 404 (secured by the hook at its first end to the elongated member 402) is secured to the lower portion of the outer surface of the truck door 100 by a fastener 420 received through an eye at the second end of the spring member 404. Aside from coil springs, any other type of resilient or elastic spring members can be employed as spring members 404, including elastic cords, elastic straps, or other suitable resilient or elastic members.

Both the top edge of the sheet 200 (with or without an upper anchoring member 300) and the resilient lower anchoring assembly 400 are secured to the outside surface of the truck door 100. Depending on the manner of securing each of the top edge of the sheet 200 and the resilient lower anchoring assembly 400 to the outside surface of the truck door 100, it is possible to mount the sheet 200 onto the door 100 while the door remains closed, or in the absence of access to an inner surface of the door or the interior of the truck cargo compartment. This would facilitate, for example, installation of the display sheet by one person working alone.

For purposes of the present disclosure and appended claims, the conjunction “or” is to be construed inclusively (e.g., “a dog or a cat” would be interpreted as “a dog, or a cat, or both”; e.g., “a dog, a cat, or a mouse” would be interpreted as “a dog, or a cat, or a mouse, or any two, or all three”), unless (a) it is explicitly stated otherwise, e.g., by use of “either . . . or”, “only one of . . . ”, or similar language; or (b) two or more of the listed alternatives are mutually exclusive within the particular context, in which case “or” would encompass only those combinations involving non-mutually-exclusive alternatives.

While the present invention has been described in terms of preferred embodiments and generally associated methods, it is contemplated that alterations and permutations thereof will become apparent to those skilled in the art upon a reading of the specification and study of the drawings. The present invention is not intended to be defined by the above description of preferred exemplary embodiments. Rather, the present invention is defined variously by the appended claims. Each variation of the present invention is intended to be limited only by the recited limitations of its respective claim, and equivalents thereof, without limitation by terms not present therein.

What is claimed is:

1. An apparatus for displaying indicia on a rear roll-up-type door of a truck comprising:
(a) a flexible sheet bearing visually perceptible indicia;
(b) an elongated pocket extending across the bottom edge of the sheet, the pocket having a plurality of transverse openings arranged along the length thereof; and
(c) a resilient lower anchoring assembly comprising an elongated substantially rigid member received within the elongated pocket and a plurality of spring members, each spring member adapted for being secured at a first end to the elongated rigid member and at a second end to the outer surface of the truck door and passing through one of the transverse openings.

2. The apparatus of claim 1 wherein:
(a) a top edge of the sheet is secured to the truck door; and
(b) each spring is secured at a first end to the elongated rigid member and at a second end to the outer surface of the truck door, and passes through one of the transverse openings.

3. The apparatus of claim 1 wherein the lower anchoring assembly is adapted for being installed onto or removed from the outer surface of the truck door while the truck door remains closed.

4. The apparatus of claim 1 wherein the lower anchoring assembly is adapted for being installed onto or removed from the outer surface of the truck door in the absence of access to an inner surface of the truck door.

5. The apparatus of claim 1 further comprising an upper anchoring member adapted for being secured to an outer surface of a roll-up-type truck door so as to secure the top edge of the sheet to the truck door.

6. The apparatus of claim 6 wherein the upper anchoring member comprises an elongated member adapted for being secured to the outer surface of the truck door over the top edge of the sheet to secure the sheet to the truck door.

7. The apparatus of claim 1 wherein:
(a) the lower anchoring assembly further comprises a plurality of eyescrews, eyebolts, or hooks adapted for being secured to the truck door; and
(b) each spring member comprises a spring with a hook at each end, the hook at the first end receiving the elongated rigid member, the hook at the lower end engaging one of the plurality of eyescrews, eyebolts, or hooks.

8. The apparatus of claim 1 wherein:
(a) the lower anchoring assembly further comprises a plurality of fasteners adapted for being secured to the truck door;
(b) each spring member comprises a spring with a hook at the first end and an eye at the second end;
(c) the hook receives the elongated rigid member to secure the first end of the spring to the elongated member; and
(d) the eye being is adapted for receiving one of the plurality of fasteners therethrough as the fastener is secured to the truck door to secure the second end of the spring to the truck door.

9. A method for installing onto a roll-up-type truck door a flexible sheet bearing visually perceptible indicia comprising:
(a) securing a top edge of the sheet to the truck door;
(b) securing a resilient lower anchoring assembly to a bottom edge of the sheet by inserting an elongated substantially rigid member of the lower anchoring assembly into an elongated pocket extending across the bottom edge of the sheet, passing each one of a plurality of spring members through a corresponding one of a plurality of transverse openings arranged along the length of the elongated pocket, and securing a first end of each spring member to the elongated rigid member; and
(c) securing the resilient lower anchoring assembly to the outer surface of the truck door by securing a second end of each of the plurality of spring members to the truck door.

10. The method of claim 9 further comprising forming the plurality of transverse openings along the length of the elongated pocket.

11. The method of claim 9 further comprising:
(d) detaching the second end of each of the plurality of spring members from the truck door;
(e) detaching the top edge of the sheet from the truck door; and
(f) removing the sheet from the truck door.

12. The method of claim 9 wherein the lower anchoring assembly is adapted for being installed onto or removed from the outer surface of the truck door while the truck door remains closed.

13. The method of claim 9 wherein the lower anchoring assembly is adapted for being installed onto or removed from the outer surface of the truck door in the absence of access to an inner surface of the truck door.

14. The method of claim 9 further comprising securing an upper anchoring member to the truck door to secure the top edge of the sheet to the truck door.

15. The method of claim 14 wherein the upper anchoring member comprises an elongated member adapted for being secured to the outer surface of the truck door over the top edge of the sheet to secure the sheet to the truck door.

16. The method of claim 9 wherein the upper anchoring member comprises an elongated member adapted for being secured to the upper portion of the outer surface of the truck door over the top edge of the sheet to secure the sheet to the upper portion of the outer surface of the truck door.

17. The method of claim 9 wherein:
(a) the lower anchoring assembly further comprises a plurality of eyescrews, eyebolts, or hooks adapted for being secured to the truck door; and
(b) each spring member comprises a spring with a hook at each end, the hook at the first end receiving the elongated rigid member, the hook at the lower end engaging one of the plurality of eyescrews, eyebolts, or hooks.

18. The method of claim 9 wherein:
(a) the lower anchoring assembly further comprises a plurality of fasteners adapted for being secured to the truck door;
(b) each spring member comprises a spring with a hook at the first end and an eye at the second end;
(c) the hook receives the elongated rigid member to secure the first end of the spring to the elongated member; and
(d) the eye being is adapted for receiving one of the plurality of fasteners therethrough as the fastener is secured to the truck door to secure the second end of the spring to the truck door.
